(19) United States
(12) Patent Application Publication
(10) Pub. No.: US 2026/0225523 A1
(43) Pub. Date: Aug. 6, 2026

(54) VEHICLE METHOD AND APPARATUS FOR PROVIDING SUPPLEMENTAL ASSISTANCE TO PEOPLE WITH HEARING IMPAIRMENTS

(71) Applicant: Volvo Car Corporation, Göteborg (SE)

(72) Inventors: Justin Gehling, Ridgeville, SC (US); Peter Laietta, III, Ridgeville, SC (US); Benjamin Carey Williams, Ridgeville, SC (US); Allison White, Ridgeville, SC (US)

(21) Appl. No.: 19/043,639

(22) Filed: Feb. 3, 2025

(51) Int. Cl. B60Q 9/00; G06F 3/16; G08G 1/0967; H04R 1/40; H04R 3/00

(52) U.S. Cl. CPC B60Q 9/00; H04R 1/406; H04R 3/005; G06F 3/162; G08G 1/0967; H04R 2499/13

(57) ABSTRACT

A system for supplementing audio signals for an occupant of a vehicle includes environmental sensors supported relative to the vehicle, at least one memory storing instructions, and one or more processors. Execution of the instructions by the processor(s) causes the processor(s) to determine, based on signals communicated from the environmental sensors, the position of a source of a sound relative to the vehicle and at least one quality of the sound. The instructions further cause the processor(s) to generate, based on the determined relative position of the source of the sound and at least one quality of the sound, an indicator via a non-auditory interface of the vehicle. The indicator indicates at least one of the determined position of the sound source relative to the vehicle or the determined at least one quality of the sound.

### INTRODUCTION

The present disclosure relates generally to the automotive field. More particularly, the present disclosure relates to supplementing audio signals encountered during use of a vehicle for an occupant, especially occupants with hearing impairments.

Operators of vehicle often use sound either consciously or subconsciously to make determinations with respect to how to operate the vehicle or the current condition of the vehicle or its components. However, a loud cabin environment may may it difficult or impossible to hear and react to sounds relevant to operation of the vehicle. Furthermore, some operators suffer from partial or total hearing loss, making it impossible or difficult to react to any or certain sounds relevant to operation of the vehicle. However, current vehicles are generally incapable of providing substitute auditory signals capable of fully or partially replacing normal auditory feedback.

As such, a need exists in the art for a system and associated methods and control systems for vehicles that overcome the above limitations. This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide a system for supplementing audio signals for an occupant of a vehicle and associated methods of operation and control systems that overcome the limitations of the known art.

Embodiments of the disclosed systems and methods facilitate monitoring for specific internal or external noises relevant to operation of the vehicle. Some embodiments activate such a system in response to an indication that the driver has a hearing impairment or that the auditory environment within the cabin of the vehicle is masking sounds relevant to operation of the vehicle. Embodiments of the disclosed system utilize external auditory environmental sensors and/or internal auditory environmental sensors to isolate external or cabin noises and determine the type of noise or relevant qualities of the noise. Utilizing non-auditory interfaces of the vehicle such as displays and haptic feedback devices, embodiments of the disclosed system may provide indicators such that the operator of the vehicle may adjust to relevant sounds that would otherwise go unheard and ignored. As non-limiting examples, embodiments of the disclosed system may alert operators to unrecognized emergency vehicle sirens; faulty, flat, underinflated, or blown out tires; faulty brakes; small impacts on the vehicle itself; collisions between other vehicles in the vicinity of the vehicles, other mechanical failures of components of the vehicle that produce sound (e.g., a whining compressor or pump about to fail); horns of other vehicles in the vicinity of the vehicle, and other noises that would typically be responded to by the operator if only they were heard in the first instance.

To achieve the foregoing and other objects and advantages, in one aspect, the present subject matter is directed to a system for supplementing audio signals for an occupant of a vehicle. The system includes a plurality of environmental sensors supported relative to the vehicle. The system further includes at least one memory storing instruction, that, when executed by one or more processors, cause the processor(s) to determine, based on signals communicated from the environmental sensors, the position of a source of a sound relative to the vehicle and at least one quality of the sound. The instructions further cause the processor(s) to generate, based on the determined relative position of the source of the sound and at least one quality of the sound, an indicator via a non-auditory interface of the vehicle. The indicator indicates at least one of the determined position of the sound source relative to the vehicle or the determined at least one quality of the sound.

In at least one embodiment, the instructions executed by the processor(s) may further cause the processor(s) to determine that the occupant has a hearing impairment. In some such embodiments or different embodiments, the position of the source of sound and at least one quality of the source of sound may be determined in response to the determination that the occupant has the hearing impairment. In an additional or alternative embodiment, the instructions executed by the processor(s) may further cause the processor(s) to determine, based on the signals communicated from the environmental sensors, that a cabin audio environment of the vehicle masks at least one of cabin or external audio signals. In some such embodiments or different embodiments, the position of the source of sound and at least one quality of the source of sound may be determined in response to the determination that the cabin audio environment of the vehicle masks at least one of cabin or external audio signals.

Additionally or alternatively, the environmental sensors may include a cabin environmental sensor and an external environmental sensor. In at least one such embodiment, the instructions executed by the processor(s) may further cause the processor(s) to determine, based on signals communicated from both the cabin environmental sensor and the external environmental sensor, the position of the source of the sound as either within the cabin of the vehicle or the external environment of the vehicle. Additionally or alternatively, each environmental sensor may include a microphone, an acoustic sensor, or a vibrational sensor.

In additional or alternative embodiments, the instructions executed by the processor(s) may further cause the processor(s) to, based on the signals communicated from the environmental sensors, select the sound for generation of the indicator from a plurality of sounds. Additionally or alternatively, the sound selected for generation of the indicator may be selected based on at least an importance of an event associated with generation of the sound or current driving conditions of the vehicle.

In further or alternative embodiments, the indicator may indicate the determined at least one quality of the sound including at least one of an intensity of the sound, a defective tire of the vehicle, a siren of another vehicle, a horn of another vehicle, an impact of the vehicle, a vehicular collision within a vicinity of the vehicle, a faulty brake of the vehicle, or a malfunction of the vehicle or an associated component. Additionally or alternatively, the non-auditory interface of the vehicle may include at least one of a haptic feedback device on a steering wheel of the vehicle, an infotainment display of the vehicle, an instrument panel of the vehicle, or a heads-up display of the vehicle. Additionally or alternatively, the indicator may indicate both the determined position of the sound source relative to the vehicle and the determined at least one quality of the sound. In additional or alternative embodiments, the instructions executed by the processor(s) may further cause the processor(s) to generate, based on the determined relative position of the source of the sound and at least one quality of the sound, an additional indicator via a different non-auditory interface of the vehicle. The additional indicator may indicate at least one of the determined position of the sound source relative to the vehicle or the determined at least one quality of the sound. In some such embodiments or different embodiments, the additional indicator may indicate additional information relative to the indicator.

In an additional or alternative aspect, the present subject matter is directed to a vehicle including a plurality of environmental sensors, a non-auditory interface, at least one memory storing instruction of an audio signal supplementation capability, and one or more processors for executing the audio signal supplementation capability. The audio signal supplementation capability includes a noise monitoring module configured to determine, based on signals communicated from the environmental sensors, a position of a source of a sound relative to the vehicle and at least one quality of the sound. The audio signal supplementation capability also includes an alert module configured to generate, based on the determined relative position of the source of the sound and the at least one quality of the sound, an indicator via the non-auditory interface of the vehicle. The indicator indicates at least one of the determined position of the sound source relative to the vehicle or the determined at least one quality of the sound.

In at least one embodiment, the audio signal supplementation capability may further include an implementation module configured to activate at least one of the noise monitoring module or the alert module based on at least one of a determination that an occupant of the vehicle has a hearing impairment or that a cabin audio environment of the vehicle masks at least one of cabin or external audio signals.

In additional or alternative embodiments, the environmental sensors may include a cabin environmental sensor and an external environmental sensor. Additionally or alternatively, the noise monitoring module may be further configured to determine, based on signals communicated from both the cabin environmental sensor and the external environmental sensor, the position of the source of the sound as either within the cabin of the vehicle or the external environment of the vehicle. Additionally or alternatively, the indicator may indicate the determined at least one quality of the sound including at least one of an intensity of the sound, a defective tire of the vehicle, a siren of another vehicle, a horn of another vehicle, an impact of the vehicle, a vehicular collision within a vicinity of the vehicle, a faulty brake of the vehicle, or a malfunction of the vehicle or an associated component. In additional or alternative embodiments, the noise activation module may be further configured to, based on the signals communicated from the plurality of environmental sensors, select the sound for generation of the indicator from a plurality of sounds.

Additionally or alternatively, the non-auditory interface of the vehicle may include at least one of a haptic feedback device on a steering wheel of the vehicle, an infotainment display of the vehicle, an instrument panel of the vehicle, or a heads-up display of the vehicle. Additionally or alternatively, the noise activation module may be further configured to generate, based on the determined relative position of the source of the sound and at least one quality of the sound, an additional indicator via a different non-auditory interface of the vehicle. In some such embodiments, the additional indicator may indicate at least one of the determined position of the sound source relative to the vehicle or the determined at least one quality of the sound. Additionally or alternatively, the additional indicator may indicate additional information relative to the indicator.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the companying drawings, in which:

FIG. 1 illustrates a schematic diagram of an exemplary embodiment of a vehicle including or suitable for use with a system for supplementing audio signals for an occupant of a vehicle, in accordance with aspects of the present subject matter;

FIG. 2 illustrates a schematic logic diagram of an exemplary embodiment of a system for supplementing audio signals for an occupant of a vehicle, in accordance with aspects of the present subject matter;

FIG. 3A illustrates an exemplary embodiment of a method including method elements, one or more of which may be implemented in a method for supplementing audio signals for an occupant of a vehicle, in accordance with aspects of the present subject matter;

FIG. 3B illustrates an exemplary embodiment of a method including additional or alternative method elements, one or more of which may be implemented in a method for supplementing audio signals for an occupant of a vehicle, in accordance with aspects of the present subject matter;

FIG. 4 illustrates an exemplary embodiment of a display of a non-auditory interface depicting indicators, in accordance with aspects of the present subject matter;

FIG. 5 illustrates a schematic diagram of an exemplary embodiment of a network of a cloud-based system for implementing various cloud-based services, in accordance with aspects of the present subject matter;

FIG. 6 illustrates a schematic diagram of an exemplary embodiment of a server which may be used in the cloud-based system of FIG. 5 or stand-alone, in accordance with aspects of the present subject matter; and

FIG. 7 illustrates a schematic diagram of an exemplary embodiment of a user device which may be used in the cloud-based system of FIG. 5 or stand-alone, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, embodiments of the disclosed systems and methods facilitate monitoring for specific internal or external noises relevant to operation of the vehicle. Some embodiments activate such a system in response to an indication that the driver has a hearing impairment or that the auditory environment within the cabin of the vehicle is masking sounds relevant to operation of the vehicle. Embodiments of the disclosed system utilize external auditory environmental sensors and/or internal auditory environmental sensors to isolate external or cabin noises and determine the type of noise or relevant qualities of the noise. Utilizing non-auditory interfaces of the vehicle such as displays and haptic feedback devices, embodiments of the disclosed system may provide indicators such that the operator of the vehicle may adjust to relevant sounds that would otherwise go unheard and ignored. As non-limiting examples, embodiments of the disclosed system may alert operators to unrecognized emergency vehicle sirens; faulty, flat, underinflated, or blown out tires; faulty brakes; small impacts on the vehicle itself; collisions between other vehicles in the vicinity of the vehicles, other mechanical failures of components of the vehicle that produce sound (e.g., a whining compressor or pump about to fail); horns of other vehicles in the vicinity of the vehicle, and other noises that would typically be responded to by the operator if only they were heard in the first instance.

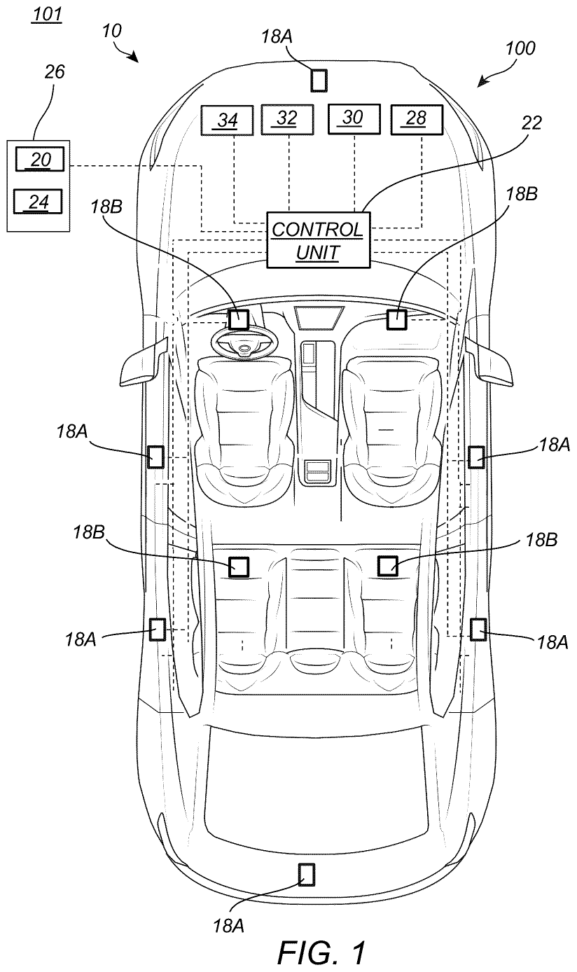

Referring now generally to FIG. 1, a schematic diagram of an exemplary embodiment of a system for supplementing audio signals for an occupant of a vehicle is illustrated in accordance with aspect of the present subject matter. As shown, a vehicle 10 may generally include a system 100 for supplementing audio signals for an occupant of the vehicle 10. Particularly, the system 100 and/or vehicle 10 may be configured to monitor a vicinity surrounding the vehicle 10 or the cabin of the vehicle 10, especially for auditory signals, sounds, or the like.

The vicinity of the vehicle 10 generally includes range or external environment around the vehicle 10 which may be auditorily monitored via appropriate sensors of the vehicle 10 and/or system 100. The vicinity and/or external environment of the vehicle 10 may be a predetermined range such as less than 25 feet, such as less than 100 feet, such as less than 150 feet, such less than 300 feet. Additionally or alternatively, the vicinity and/or external environment of the vehicle 10 may be determined based on the external environment surrounding the vehicle 10 and/or a real-time ability of suitable sensors of the vehicle to determine the external environment surrounding the vehicle 10, especially with respect to sounds, auditory signals, and the like. Such vicinity and/or external environment of the vehicle 10 may be determined utilizing one or more appropriate artificial intelligence algorithms and based on external environmental data, especially sound or vibrational data. Generally, the vicinity and/or external environment of the vehicle 10 may also be based, at least in part, on a detectable range of one or more external vehicle sensors 18A. For instance, the vicinity and/or external environment of the vehicle 10 may be limited by at least an external vehicle sensor 18A having the furthest accurate range of measurement, e.g., a predetermined accurate range or an accurate range determined based on the environmental context surrounding the vehicle 10.

As further illustrated in FIG. 1, the vehicle 10 and/or system 100 includes one or more environmental sensors 18, such as external environmental sensor(s) 18A and/or internal or cabin environmental sensor(s) 18B. Various configurations of vehicles include additional, fewer, or alternatively placed environmental sensors 18. Generally, the environmental sensors 18 may include one or more microphones, acoustic sensors, vibrational sensors, or the like suitable to capture data indicative of audible sound in the external environment and/or cabin of the vehicle 10. It should be appreciated that, in some embodiments of the vehicle 10 and/or system 100, the environmental sensors 18 may additionally or alternatively include one or more cameras, LiDAR sensors, radar sensors, proximity sensors, impact sensors, infrared sensors, optical sensors, seat sensor(s), or other sensors utilized or not utilized in conjunction with the system 100. In some embodiments and as shown, the environmental sensor(s) 18 may include the internal environmental sensor(s) 18B, such as a cabin sensor.

Additionally or alternatively, the external environmental sensor(s) 18A may include one or more of a front sensor configured to capture data indicating a portion of the external environment of the vehicle 10 associated with a front bumper of the vehicle 10, a rear sensor configured to capture data indicating a portion of the external environment of the vehicle 10 associated with a rear bumper of the vehicle 10, a driver-side sensor configured to capture data indicating a portion of the external environment of the vehicle 10 associated with a driver side of the vehicle 10, a passenger-side sensor configured to capture data indicating a portion of the external environment of the vehicle 10 associated with a passenger side of the vehicle 10, a front-driver-corner sensor configured to capture data indicating a portion of the external environment of the vehicle 10 associated with a front-driver corner of the vehicle 10, a front-passenger-corner sensor configured to capture data indicating a portion of the external environment of the vehicle 10 associated with a front-passenger corner of the vehicle 10, a rear-driver-corner sensor configured to capture data indicating a portion of the external environment of the vehicle 10 associated with a rear-driver corner of the vehicle 10, or a rear-passenger-corner sensor configured to capture data indicating a portion of the external environment of the vehicle 10 associated with a rear-passenger corner of the vehicle 10. For example, the vehicle 10 and/or system 100 may include a microphone, an acoustic sensor, a vibrational sensor, or the like at one or multiple of these locations. Similarly, the vehicle 10 and/or system 100 may additionally or alternatively include other sensors, such as one or more optical sensors, at one or multiple of these locations or different locations. Any of these sensors or other dedicated sensors may be positioned and/or configured to monitor specific components of the vehicle 10 (e.g., tires, brakes, the engine, etc.), especially for the production of sound.

The vehicle 10 and/or system 100 include one or more memory devices storing instructions that, when executed by one or more processors, cause the processor(s) to carry out one or more logical steps or method elements for supplementing audio signals for an occupant of a vehicle, as described herein. In some embodiments and as shown, the vehicle 10 and/or system 100 may further include a control unit 22 (e.g., an electronic control unit, multiple associated control units, and/or a combination of one or more processing devices and at least one memory or memory device as described herein) communicatively coupled to one or more of the environmental sensor(s) 18, one or more external device(s) 26 such a mobile device 20 of the operator/owner, and/or other components of the vehicle 10 and/or system 100, described in more detail in the following description. The control unit 22 may be configured to direct operation of one or more of such components in accordance with aspects of the present subject matter.

While a single control unit 22 is illustrated in FIG. 1 for simplicity, it should be appreciated that the control unit 22 may include multiple associated control units, electronic control units, processing devices, memory devices, or the like that together are configured to provide operational control of the vehicle 10, the system 100, the environmental sensor(s) 18, user interface components 32 of the vehicle 10, and/or other components of the vehicle 10 and/or system 100. The control unit 22 may additionally or alternatively facilitate communication between the vehicle 10, the system 100, the external device(s) 26, mobile device(s) 20, the environmental sensor(s) 18, the external environment of the vehicle 10, the internal or cabin environment of the vehicle 10, and/or user interface components 32 (e.g., internal screens, touchscreens, displays, a steering wheel, haptic feedback devices, an infotainment display, a dashboard display, a heads-up display, or the like) of the vehicle 10. Generally, the control unit 22 may be configured to receive a signal or data indicative of the environmental context surrounding the vehicle 10 and/or the environmental context of the cabin of the vehicle 10, especially sound, vibrations, and/or acoustic signals.

In operation, the control unit 22 generally identifies sounds within the external environment and/or cabin of the vehicle, determines a position of a source of the sound and a quality of the sound, and generates an indicator via a non-auditory interface of the vehicle indicating the determined position of the sound source and/or the determined quality of the sound. Optionally, the control unit 22 may implement such a process in response to determining that an occupant of the vehicle 10 has a hearing impairment; in response to determining a cabin audio environment (e.g., sound intensity, sound pitch, or variety of sounds) of the vehicle 10 masks cabin or external audio sounds, signals, etc. ; or in response to an interface prompt provided by the occupant of the vehicle 10 implementing such a system, method, or associated control logic. The control unit 22 may generally make any such determination based, at least in part, on the environmental data, especially sound or acoustic data, provided by the environmental sensors 18, such as external environmental or audio sensors, cabin environment or audio sensors, or a combination thereof. The determined quality or qualities of the sound may include one or more of an intensity of the sound, a defective tire of the vehicle, a siren of another vehicle, a horn of another vehicle, an impact of the vehicle, a vehicular collision within a vicinity of the vehicle, a faulty brake of the vehicle, or a malfunction of the vehicle or an associated component.

The indicator provided via one or multiple of the non-auditory user interface components 32 may include distinct outputs for each type of such determined qualities and/or may indicate an associated degree of a quality, e.g., the indicator may represent louder sound intensity differently than a quiet sound intensity. The indicator may also provide information regarding whether the sounds source is external or internal (within the cabin), the type of sound source, or an importance of the source of sound. For example, sounds associated with failures of the vehicle 10 and/or its components or collisions may be highlighted or focused on relative to other sounds sources that are less important or critical to operation of the vehicle 10, e.g., an adjacent vehicle backfiring. In some instances, the source of the sound may include an impact on the vehicle 10 loud enough to be sensed by one or more of the environmental sensors 18 and/or indicated in signals communicated therefrom. Such impacts may include, without limitation, an impact from a moving vehicle, an impact from a grocery cart, an impact from a vehicle door, impacts from objects (e.g., baseball bats, tire irons, bird strikes, rocks on the windshield, hail impacts, etc.), or the like.

Furthermore, the control unit 22 may include or utilize one or more artificial intelligence (AI) programs to make some or all of such determinations or different determination. For example, a suitably trained AI program, subroutine, module, or the like may determine the appropriate external environment around the vehicle 10 to monitor, adjust the monitored external environment based on determined qualities of the external environment and/or the cabin of the vehicle 10, determine the source of a sound, determine the position of the source of the sound relative to the vehicle 10 including whether the source is within the vehicle, is within the external environment of the vehicle, and/or is component of the vehicle, or, determine the one or more qualities of the sound, such as the type of sound or a likely cause of the sound.

Referring still to FIG. 1, the vehicle 10 generally includes a plurality of seats, seat assemblies, occupant suites, or the like. The number, position, and orientation of the components illustrated in FIG. 1 are provided as an example, and it should be appreciated that alternative embodiments of the vehicle 10 may include fewer, additional, or alternatively configured components so long as such components are suitable to implement the logical steps and/or method elements disclosed herein. For example, only a portion of the seat assemblies may be provided with certain cabin environmental sensors 18B, e.g., dedicated cabin microphone, camera, or the like, such as some but not all of the rear seats.

Furthermore, other embodiments of the vehicle 10 and/or system 100 may include or be associated with more, fewer, or differently positioned/oriented external environmental sensors 18A, cabin environmental sensors 18B, and/or the non-auditory interface(s) 32. Alternatively or additionally, doors of the vehicle 10 adjacent to one another may share one or more external environmental sensors 18A or even lack such components. Furthermore or alternatively, the one or more corners of the vehicle 10 may be provided with dedicated external environmental sensors 18A. Some embodiments of the vehicle 10 and/or system 100 may not include the front external environmental sensor 18A and/or the rear external environmental sensor 18A.

As shown, at least some of the previous occupants of vehicle 10, such as at least the operator or owner of the vehicle 10 may be associated with a mobile device 20 (e.g., a cellular phone, tablet, laptop, MP4/MP3 audio device, smart watch, smart glasses, wearable technology, or the like). Thus and in some embodiments, the environmental sensor(s) 18 may include one more receivers/transceivers suitable to establish a wired or wireless connection (e.g., a near-field connection, a local area network connection, a Wi-Fi connection, a Bluetooth connection, or the like) between the vehicle 10, the system 100, and/or an associated control unit 22 and the mobile device(s) 20 of the occupant(s), operator(s), owner(s), etc. Optionally, one or more of such connections may be provided, at least partially, through the cloud.

In some embodiments, the vehicle 10 may be an electric vehicle having electrical components (e.g., one or more electric motors, associated batteries, etc.) for propelling the vehicle 10. Additionally or alternatively, the vehicle 10 may be configured with a rear-mounted or front-mounted internal combustion engine (ICE). In other embodiments, the vehicle 10 may be configured as a hybrid vehicle, which is driven by both a petroleum product (e.g., gas, diesel, jet fuel, and the like) and electrical power. Some embodiments of the vehicle 10 may include autonomous capability of varying degrees. It will be appreciated that the exemplary vehicle(s) 10 depicted and described herein are by way of example only, and, in other exemplary embodiments, the vehicle 10 may have any other suitable configuration, including, for example, any other suitable number of rows of seats, rows of doors, etc. Similarly, the vehicle 10 may have any other suitable number and position of doors, external environmental sensors 18A, cabin environmental sensors 18B, and the like. Additionally or alternatively and in other exemplary embodiments, any other suitable power sources may be provided. For example, the vehicle 10 may include a liquid or gaseous hydrogen powered engine, a gas turbine engine, an inboard motor, an outboard motor, etc.

While embodiments of the vehicle 10 herein may be illustrated or described as an automotive vehicle, it should be appreciated that the present disclosure is equally applicable to any other form of transportation (e.g., trains, boats, busses, passenger rail cars, and the like) where supplementing audio signals for an occupant of a vehicle 10 is desired or required. Thus, regardless of the type of power train, design, or model of the vehicle 10, the vehicle 10 may include or be utilized with embodiments of the system 100, as described herein.

The control unit 22 (e.g., an electronic control unit, multiple associated control units, and/or a combination of one or more processing devices and at least one memory or memory device as described herein) is generally communicatively coupled to the environmental sensor(s) 18, the mobile device(s) 20 of the occupant(s)/owner(s)/operator(s), the interface components or devices of the vehicle 10, including the non-auditory interface(s) 32, and/or other components of the vehicle 10 and/or system 100. The control unit 22 may be configured to direct operation of one or more of such components in accordance with aspects of the present subject matter.

Generally, the control unit 22 may be configured to receive a signal or data indicative of an auditory, vibrational (e.g., vibrations associated with sound production), and/or acoustical external environment surrounding the vehicle 10 and/or the cabin of the vehicle 10. Based on such received signals or data or in response to, the control unit 22 may generally determine the position of the source of the sound relative to the vehicle 10 and/or the one or more qualities of the sound as described herein. The control unit may be configured to thereafter generate the indicator indicating the determined position of the sound source relative to the vehicle 10 and/or the determined quality(ies) of the sound via the one or more of the non-auditory interfaces 32 of the vehicle 10.

Furthermore and as shown in FIG. 1., the control unit 22 may receive vehicle parameters from various additional or alternative components of the vehicle 10 or components associated with the vehicle 10 to similarly provide operational control, feedback, or input information, as described in more detail below. Furthermore, the control unit 22 may include or be communicatively coupled with one or more external devices 26, such as the mobile device 20, a remote device 24 (e.g., memory device, a server, a cloud system), or the like. In some embodiments, the external device(s) 26, the mobile device(s) 20, the remote device 24, and/or the cloud may function as a repository of stored data indicating or associated with previously analyzed sounds.

While some communication links in FIG. 1 may be illustrated as joint communication links, it should be appreciated that one or more components communicatively coupled to the control unit 22, such as all of the components, may have component dedicated communication links (e.g., wireless or wired communication links with the control unit 22).

By applying an appropriate algorithm in the control unit 22, the system 100 can be integrated with the rest of the vehicle systems, with input from/output to a vehicle power source 28 (e.g., one or more electric motors, ICE motors, or associated control systems, monitors, sensors, etc.), a vehicle power supply 30 (e.g., one or more batteries, gas tanks, or associated control systems, monitors, sensors, etc.), the non-auditory interface(s) 32 (e.g., screens, displays, or touch screens of an infotainment unit or system, an instrument panel of the vehicle 10, a heads-up display, and/or haptic feedback devices included in one or more components of the vehicle 10 such as the operator seat and/or the steering wheel of the vehicle 10), an audio system 34 (e.g., one or more control systems, amplifiers, preamplifiers, or the like), the environmental sensor(s) 18, the external device(s) 26, the mobile device(s) 20, and/or the remote device 24. In several embodiments, some of such devices, such as all of such devices, may each include or be associated with a suitable mobile application, a suitable cloud application, and/or a suitable application programming interface configured to provide external information and/or instructions to the control unit 22.

In some embodiments, besides controlling the operation of the vehicle 10, system 100, and/or included or associated components thereof, the control unit 22 may also provide useful information to the operator via the mobile device(s) 20 and/or user interface components 32, such as a display or touch screen thereof. Associated user interface(s) 32 may include one or more buttons, switches, touch screen capability, or the like allowing the operator/owner of the vehicle 10 to communicate inputs to the control unit 22 utilized to control operation of the vehicle 10, system 100, and/or components or subsystems thereof.

With respect to the external environmental sensor(s) 18A, such sensors 18A may generally be configured to communicate one or more signals suitable for the control unit 22 to recognize sounds or noises within the external environment of the vehicle 10 and/or the cabin of the vehicle 10, determine a position of the source of sounds and the one or more qualities of the sound, and generation of the indicator. The signal(s) communicated from such sensor(s) 18A may further indicate the type of environment surrounding the vehicle 10 (e.g., remote, urban, private property, parking lot, forest, planes, etc.); transitory conditions of the external environment surrounding the vehicle 10 (e.g., weather, lighting conditions, wind direction, traffic density, etc.); external environmental sounds; cabin sounds; and/or characteristics of such sounds. With respect to the internal environmental sensor(s) 18B, such sensors 18B may generally be configured to communicate one or more signals suitable for the control unit 22 to determine, without limitation, that the vehicle 10 is unoccupied.

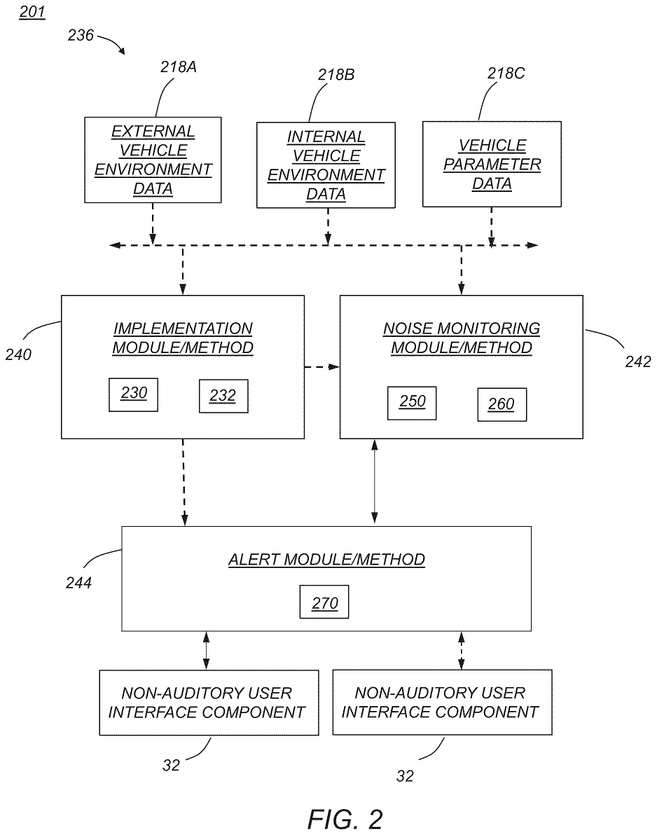

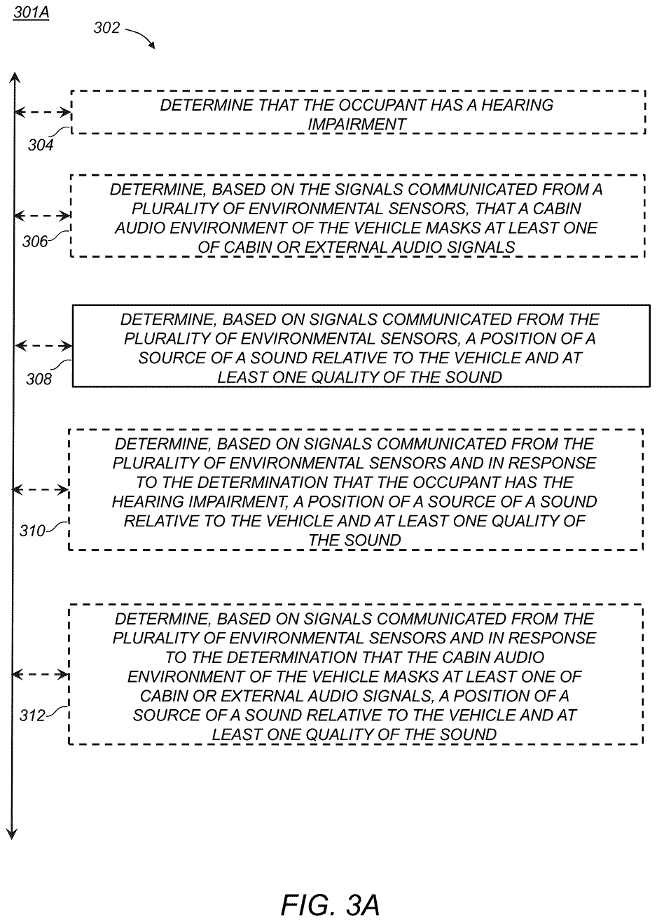

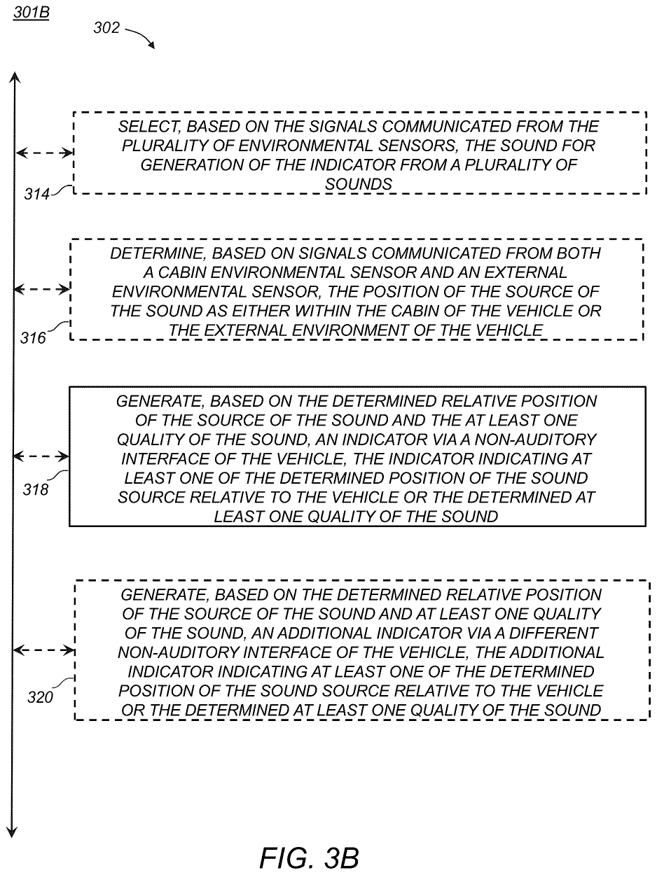

Referring now to FIGS. 2-3, FIG. 2 illustrates a schematic logic diagram of an exemplary embodiment of a system for supplementing audio signals for an occupant of a vehicle in accordance with aspects of the present subject matter; FIG. 3A illustrates method elements, one or more of which may be implemented in a method for supplementing audio signals for an occupant of a vehicle in accordance with aspects of the present subject matter; and FIG. 3B illustrates additional or alternative method elements, one or more of which may be implemented in a method for supplementing audio signals for an occupant of a vehicle in accordance with aspects of the present subject matter.

The logic diagram depicted in FIG. 2 (control logic 236) and/or the method or process (method 302) depicted in one or more of FIGS. 3A and/or 3B may be utilized to control or in association with embodiments of the vehicle 10 and/or the system 100 as described above with respect to FIG. 1, any of the components or subsystems thereof, such as the environmental sensor(s) 18, the control unit 22, the external device(s) 26, the mobile device(s) 20, the remote device(s) 24, vehicle power source(s) 28, the vehicle power supply(ies) 30, the user interface components 32 including the non-auditory user interface components, the audio system 34 (if not already included or embedded within control unit 22), other control systems or monitoring system of the vehicle 10, such as an electronic vehicle control system configured to provide general operational control of the vehicle 10, or other systems or components utilized in association with operation of the vehicle 10, such as navigation systems and/or a global positioning system, sensors, etc. However, it should be appreciated that the control logic 236 and/or the method 302 may be utilized to control or in association with embodiments of other similar or suitably configured vehicles, systems for supplementing audio signals for an occupant of a vehicle, and/or components or subsystems thereof. The control logic 236 may include one or more modules including instructions stored in at least one memory and executable by one or more processors to cause the processor(s) to implement steps, method elements, or the like as described herein. For example, elements of the control logic 236 and/or method 302 may be implemented, at least in part, by the control unit 22 and stored in memory associated with the control unit 22 and/or included with or accessible by the vehicle 10.

The control logic 236 may include one or more modules such an implementation module noise monitoring module 242, an alert module 244, and/or multiple modules, sub-routines, or the like suitable to execute at least one, some, or all of the elements of method 302. The module 240, 242, 244 may include instructions stored in at least one memory and executable by one or more processors to cause the processor(s) to implement steps, method elements, or the like as described herein. For example, elements of the control logic 236 and/or method 302 may be implemented, at least in part, by the control unit 22 and stored in memory associated with the control unit 22 and/or included with or accessible by the vehicle 10.

The implementation module 240 is generally configured to activate the noise monitoring module 242, the alert module 244, or both based a determination that an occupant of the vehicle 10 has a hearing impairment or that a cabin audio environment of the vehicle 10 masks at least one of cabin or external audio signals. For example, the method 302 may include determining that the occupant has a hearing impairment, method element 304. As described in more detail below, the position of the source of sound and the at least one quality of the source of sound may be determined in response to the determination that the occupant has the hearing impairment. In additional or alternative embodiments, the method 302 may include determining, based on the signals communicated from the environmental sensors, that a cabin audio environment of the vehicle masks at least one of cabin or external audio signals (method element 306).

The control logic 236 and/or method 302 may additionally or alternatively include receiving data 218A communicated from the external environmental sensor(s) 18A and indicating the audio environmental context surrounding the vehicle 10. The control logic 236 and/or method 302 may additionally or alternatively include receiving data 218 communicated from the cabin environmental sensor(s) 18B and indicating the internal or cabin audio environment of the vehicle 10. For example, internal vehicle environmental data 218B may be communicated from the internal environmental sensor(s) 18B and indicate the internal environment or cabin environment of the vehicle 10. The control logic 236 and/or method 302 may additionally or alternatively include receiving vehicle parameter data 218C communicated from one or more components or systems included in or associated with the vehicle 10 and/or system 100, e.g., engine parameters, geographical location, elevation information, power supply information, or the like.

In some embodiments, the implementation module 240 and/or method 302 may be configured to activate one or both of the noise monitoring module, the alert module, and/or associated elements of method 302 (described in more detail below) in response to an input received via an interface device 32 of the vehicle 10 indicating that supplementing audio signals for an occupant of the vehicle 10 or activating native or after-market audio signal supplementation capability is desired, such as via an accessible setting. Additionally or alternatively, one or more suitable AI programs may be configured to determine that the occupant has a hearing impairment (AI program 230) and/or that the cabin audio environment of the vehicle 10 masks cabin or external audio signals (AI program 232) based on external vehicle environment data 218B (such as audio data) communicated from the external environmental sensor(s) 18A, internal vehicle environment data 218B (such as audio data) communicated from the cabin environmental sensor 18B, and/or vehicle parameter data 218C communicated from other system or components of the vehicle 10, e.g., the vehicle power source 28, the vehicle power supply 30, the audio system 34, the electronic vehicle control system, the navigation or global positioning system, or other systems or components utilized in association with operation of the vehicle 10.

Thus, it should be appreciated that various aspects of the control logic 236, the method 302, or parts or components thereof may generally be implemented utilizing one or more artificial intelligence algorithms (e.g., AI algorithm(s) 230, 240, 250, 260, or 270) and based on the external vehicle environment data 218A, the internal vehicle environment data 218B, and/or the vehicle parameter data 218C, especially portion of such data indicating sounds, audio signals, and the like. As non-limiting examples, determining that the position of the source of the sound relative to the vehicle 10, determining the one or more qualities of the sound, and generating the appropriate indicator or features thereof may utilize one or more suitably trained AI programs, e.g., AI programs 250, 260, and/or 270, respectively.

The AI algorithm(s) 230, 232, 250, 260, and/or 270 may include one or more algorithms, programs, modules, and the like suitable to simulate intelligence human behavior or perform tasks historically requiring human implementation. For example, the AI algorithm(s) may include, without limitation, one or more of machine learning algorithms, artificial neural networks, recurrent artificial neural networks, feedforward neural networks, convolutional neural networks, recurrent neural networks, deep neural networks, natural language processing algorithms, long short term memory networks, inductive logic programming algorithms, support vector machines, clustering algorithms, Bayesian networks, reinforcement learning algorithms, representation learning algorithms, similarity and metric learning algorithms, sparse dictionary learning algorithms, genetic algorithms, k-nearest neighbor (KNN) algorithms, decision tree learning algorithms, association rule learning algorithms, and the like. Some of the AI algorithm(s) 230, 232, 250, 260, and/or 270 described herein may be trained (via a supervised or unsupervised training process) based on training data provided to the AI algorithm(s) 230, 232, 250, 260, and/or 270. In one optional configuration, the AI algorithm(s) utilizes a neural network (NN), such as a convolutional neural network (CNN), that is trained to segment and annotate images and/or identify sounds based on experiential learning. The AI algorithm(s) may utilize computer vision (CV), computer hearing (CH), and/or deep learning (DL) algorithms applied to the obtained images and/or sounds to enable both object and scenario detection, as well as wide area condition detection—is the scene urban, rural, a mountain, a seashore, a bridge; is the external environment and/or vicinity of the vehicle wet, slippery, windy, is there an accident, unconscious pedestrian, or an emergency vehicle; etc.?

Such process may further enable both interior and external situational awareness - is the vehicle 10 unoccupied or is the operator simply taking a nap in the vehicle 10; is the vicinity and/or external environment of the vehicle 10 noisy, crowded, a high-foot-traffic area, quiet, a low-foot-traffic area? The present disclosure is agnostic related to these AI methodologies, and any suitable AI methodologies may be utilized equally. It should be appreciated that various embodiments of the method 302 and/or disclosed system 100 are primarily directed to supplementing audio signals for occupants of vehicles and/or implementing an audio signal supplementation capability of the vehicles.

Referring still to FIGS. 2 and 3, the control logic 236 may include the noise monitoring module/method 242 configured to determine, based on signals 218 communicated from the environmental sensors 18, a position of the source of the sound relative to the vehicle 10 and at least one quality of the sound. Additionally or alternatively, the method 302 may include determining, based on signals communicated from the plurality of environmental sensors, a position of a source of a sound relative to the vehicle and at least one quality of the sound, method element 308. It should be appreciated that the quality(ies) of the sound may indicate a type of event or source generating or likely generating the sounds, and/or may be sufficient for a suitably trained AI program 260 to determine the same. The possible qualities of the sound may include, but is not limited to, an intensity of the sound, a defective tire of the vehicle 10, a siren of another vehicle, a horn of another vehicle, an impact of the vehicle 10, a vehicular collision within a vicinity of the vehicle 10, a faulty brake of the vehicle, or a malfunction of the vehicle or an associated component. As explained in more detail below, one or more indicators may be associated with each of these potential qualities of the sound and/or associated types of sound sources.

Additionally or alternatively, the method 302 may include determining based on signals communicated from the plurality of environmental sensors and in response to the determination that the occupant has the hearing impairment, a position of a source of a sound relative to the vehicle and at least one quality of the sound (method element 310). Additionally or alternatively, the method 302 may include determining based on signals communicated from the plurality of environmental sensors and in response to the determination that the cabin audio environment of the vehicle masks at least one of cabin or external audio signals, a position of a source of a sound relative to the vehicle and at least one quality of the sound (method element 312).

It should be appreciated that the external environment and/or cabin of the vehicle 10 may include numerous sounds or noises. Furthermore, indicating each present sound or noise may not be feasible or even desirable, as providing an operator of the vehicle 10 with too much information may confuse the operator and/or cause the operator to ignore the indicators provided via the non-auditory interface 32 of the vehicle. Thus, the control logic 236 and/or noise monitoring module 242 may be configured to select, based on the signals communicated from the plurality of environmental sensors, the sound for generation of the indicator from a plurality of sounds. (See also method element 314). For example, the sound selected for generation of the indicator may be based at least on an importance of an event associated with generation of the sound and/or a current driving condition of the vehicle. For example, the AI program(s) of the noise monitoring module (e.g., AI program 250, 260 or other suitably configured AI programs) may be configured to determine the importance of the event associated with the generation of the sound based on the vehicle environment data, especially the audio data thereof. It should be appreciated that non-audio data (e.g., optical data and/or vehicle parameter data 218C) may additionally or alternatively be utilized to determine the importance of the event associated with the generation of the sound and/or the current driving condition of the vehicle 10.

In some embodiments, the vehicle environment data 218 includes external vehicle audio data 218A and internal vehicle audio data 218B. In some such embodiments, the control logic 236 and/or noise monitoring module 242 may be configured to determine the position of the source of the sound as either within the cabin of the vehicle 10 or the external environment of the vehicle 10. For example, the method may include determining, based on signals communicated from both the cabin environmental sensor and the external environmental sensor, the position of the source of the sound as either within the cabin of the vehicle or the external environment of the vehicle (method element 414). It should be appreciated that the external/cabin location determination may also be indicative of the quality of the sound and/or the type of event generating the sound. For example, determining that the position of the source of the sound is external and over a predetermined threshold distance from the vehicle 10 may be utilized to determine qualities of the sound, a source of the sound, and/or a type of sound that cannot be local to the vehicle 10. Thus, the current system 100 may determine that the sound is not associated with defective vehicle tires of the vehicle 10, faulty brakes of the vehicle 10 (e.g., old screeching brakes), impacts on or involving the vehicle 10, or other malfunction, worn, or damages components of the vehicle 10 itself.

Referring still to FIGS. 2 and 3, the control logic 236 may include the alert module/method 244 configured to generate an indicator via a non-auditory interface 32 of the vehicle 10 and based on the determined relative position of the source of the sound and the one or more determined qualities of the sound. The indicator generally indicates the determined position of the sound source relative to the vehicle, the determined one or more qualities of the sound, or both. Additionally or alternatively, the method 302 may include generating, based on the determined relative position of the source of the sound and the at least one quality of the sound, an indicator via a non-auditory interface of the vehicle, the indicator indicating at least one of the determined position of the sound source relative to the vehicle or the determined at least one quality of the sound (method element 318). In some embodiments, the indicator may indicate both the determined position of the sound source relative to the vehicle 10 and the determined quality(ies) of the sound. The non-auditory interface 32 may include one or more of a haptic feedback device on a steering wheel of the vehicle 10, an infotainment display of the vehicle 10, an instrument panel of the vehicle 10, a heads-up display of the vehicle 10, or the like.

In embodiments where the non-auditory interface 32 includes the haptic feedback devices of the steering wheel, the steering wheel may include multiple imbedded or coupled haptic feedback devices arranged on the steering wheel allowing the determined position of the sound source to be indicated. For example, two or more haptic feedback devices may be included with the steering wheel and capable of indicating that the determined source of sound is positioned one or more of on the driver side of the vehicle 10, on the passenger side of the vehicle 10, forward of the vehicle 10, aft of the vehicle 10, or colinear with the vehicle 10 via activation of the appropriate haptic feedback device or combination of haptic feedback devices. Furthermore, the intensity of the output of the haptic feedback device(s) may indicate, for example, a sound intensity of the sound, a distance of the sound source from the vehicle, and/or an importance of the event associated with production of the sound or the sound source.

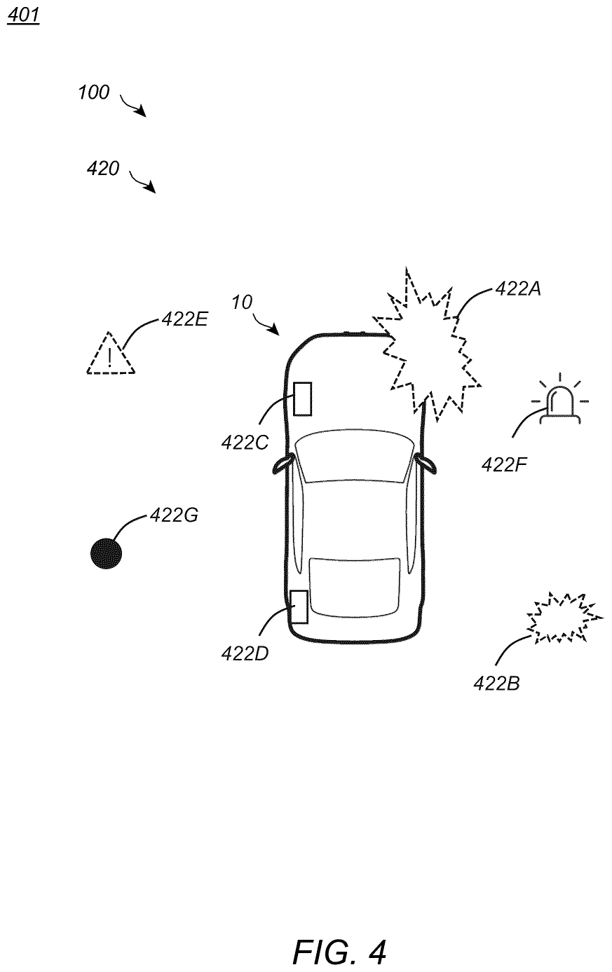

Referring now to FIG. 4, a schematic drawing of an exemplary display is illustrated depicting indicators and that may be produced by any of the visual and non-auditory interfaces described herein. As shown, the display 420 may include a representation of the vehicle 10 and one or more representations of indicators 422 that represent the position of associated sources of sound, as determined by the system 100 and described herein. The indicators may also indicate the determined quality(ies) of the sound via selection of different symbols for the indicators 422. As non-limiting examples and as shown, a first symbol 422A may indicate an impact or collision involving the vehicle 10, a second symbol 422B may indicate a collision involving another vehicle in the vicinity of the vehicle 10, a third symbol 422C may indicate a defect involving an associated tire (blown out tire, a tire rubbing other components of the vehicle 10, etc.) of the vehicle 10, a fourth symbol 422D may indicate a worn of faulty associated brake of the vehicle 10, a fifth symbol 422E may indicate an issue with another vehicle in the vicinity of the vehicle 10 that the system 100 or associated AI programs have determined are important to operation of the vehicle 10 in question (e.g., a tire blow out of an adjacent vehicle 10, the horn of an adjacent vehicle 10, or the like), a sixth symbol 422F may indicate another vehicle operating a siren in the vicinity of the vehicle 10, and a seventh symbol 422G may indicate an intensity of a loud noise and/or the position of the source when the cause of the sound has yet to be determined. It should be appreciated that additional or alternative symbols or features of the symbols may indicate other qualities of the sound determined by the system 100, and as described herein. For example, the color, size, thickness, pulsating images, or the like may indicate sound intensity, importance of the cause of the sound, closeness to the vehicle 10, or other information useful for operation of the vehicle 10.

Referring now to FIGS. 2-4, the alert module 244 may additionally or alternatively operate to generate an additional indicator via the same or a different non-auditory interface 32 of the vehicle 10 based on the determined relative position of the source of the sound and at least one quality of the sound. The additional indicator indicates at least one of the determined position of the sound source relative to the vehicle 10 or the determined quality(ies) of the sound. Additionally or alternatively, the method 302 may include generating, based on the determined relative position of the source of the sound and at least one quality of the sound, an additional indicator via a different non-auditory interface of the vehicle, the additional indicator indicating at least one of the determined position of the sound source relative to the vehicle or the determined at least one quality of the sound (method element 320). The additional indicator generally indicates additional information relative to the indicator 422. For example, the additional indicator may be a second or subsequent of the indicators 422 illustrated in FIG. 4. Additionally or alternatively, the original indicator may be haptic feedback of the steering wheel indicating the determined position of the sound source and/or intensity of the sound. The additional indicator may be an indicator 422 of FIG. 4 indicating determined information identifying the source of the sound (e.g., the cause or likely cause).

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

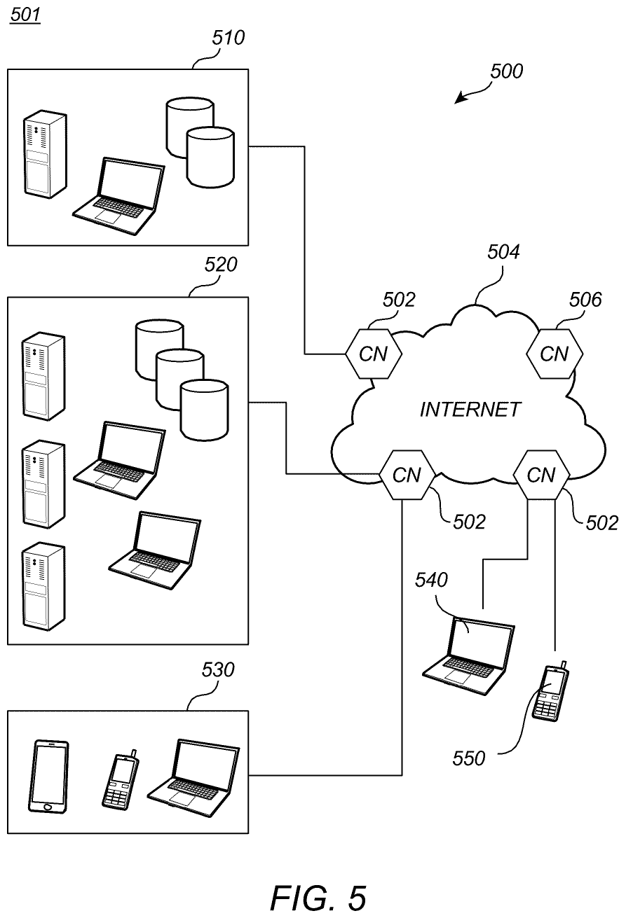

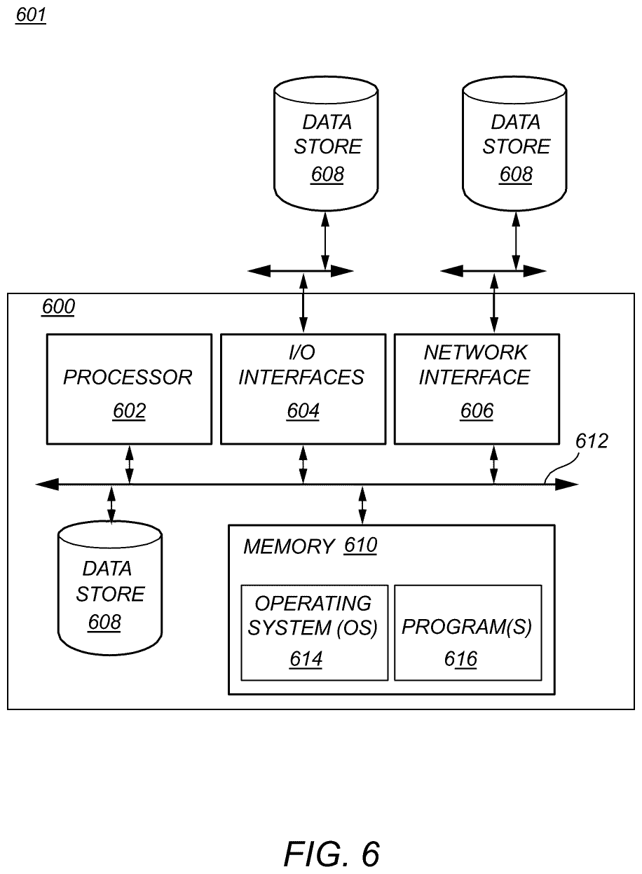

FIG. 5 is a network diagram of a cloud-based system 500 for implementing various cloud-based services of the present disclosure. The cloud-based system 500 includes one or more cloud nodes (CNs) 502 communicatively coupled to the Internet 504 or the like. The cloud nodes 502 may be implemented as a server 600 (as illustrated in FIG. 6) or the like and can be geographically diverse from one another, such as located at various data centers around the country or globe. Further, the cloud-based system 500 can include one or more central authority (CA) nodes 506, which similarly can be implemented as the server 600 and be connected to the CNs 502. For illustration purposes, the cloud-based system 500 can connect to a regional office 510, headquarters 520, various employee's homes 530, laptops/desktops 540, and mobile devices 550, each of which can be communicatively coupled to one of the CNs 502. These locations 510, 520, and 530, and devices 540 and 550 are shown for illustrative purposes, and those skilled in the art will recognize there are various access scenarios to the cloud-based system 500, all of which are contemplated herein. The devices 540 and 550 can be so-called road warriors, i.e., users off-site, on-the-road, etc. The cloud-based system 500 can be a private cloud, a public cloud, a combination of a private cloud and a public cloud (hybrid cloud), or the like.

Again, the cloud-based system 500 can provide any functionality through services, such as

software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 510, 520, and 530 and devices 540 and 550. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 500 is replacing the conventional deployment model. The cloud-based system 500 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 500 is illustrated herein as one example embodiment of a cloud-based system, and those of ordinary skill in the art will recognize the systems and methods described herein are not necessarily limited thereby.

FIG. 6 is a block diagram of a server 600, which may be used in the cloud-based system 500 (FIG. 5), in other systems, or stand-alone. For example, the CNs 502 (FIG. 5) and the central authority nodes 506 (FIG. 5) may be formed as one or more of the servers 600. The server 600 may be a digital computer that, in terms of hardware architecture, generally includes a processor 602, input/output (I/O) interfaces 604, a network interface 606, a data store 608, and memory 610. It should be appreciated by those of ordinary skill in the art that FIG. 6 depicts the server 600 in an oversimplified manner, and a practical embodiment may include additional components and suitably configured processing logic to support known or conventional operating features that are not described in detail herein. The components (602, 604, 606, 608, and 610) are communicatively coupled via a local interface 612. The local interface 612 may be, for example, but is not limited to, one or more buses or other wired or wireless connections, as is known in the art. The local interface 612 may have additional elements, which are omitted for simplicity, such as controllers, buffers (caches), drivers, repeaters, and receivers, among many others, to enable communications. Further, the local interface 612 may include address, control, and/or data connections to enable appropriate communications among the aforementioned components.

The processor 602 is a hardware device for executing software instructions. The processor 602 may be any custom made or commercially available processor, a central processing unit (CPU), an auxiliary processor among several processors associated with the server 600, a semiconductor-based microprocessor (in the form of a microchip or chipset), or generally any device for executing software instructions. When the server 600 is in operation, the processor 602 is configured to execute software stored within the memory 610, to communicate data to and from the memory 610, and to generally control operations of the server 600 pursuant to the software instructions. The I/O interfaces 604 may be used to receive user input from and/or for providing system output to one or more devices or components.

The network interface 606 may be used to enable the server 600 to communicate on a network, such as the Internet 504 (FIG. 5). The network interface 606 may include, for example, an Ethernet card or adapter (e.g., 10BaseT, Fast Ethernet, Gigabit Ethernet, or 10GbE) or a Wireless Local Area Network (WLAN) card or adapter (e.g., 802.11a/b/g/n/ac). The network interface 606 may include address, control, and/or data connections to enable appropriate communications on the network. A data store 608 may be used to store data. The data store 608 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media. In one example, the data store 608 may be located internal to the server 600, such as, for example, an internal hard drive connected to the local interface 612 in the server 600. Additionally, in another embodiment, the data store 608 may be located external to the server 600 such as, for example, an external hard drive connected to the I/O interfaces 604 (e.g., a SCSI or USB connection). In a further embodiment, the data store 608 may be connected to the server 600 through a network, such as, for example, a network-attached file server.

The memory 610 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 510 may incorporate electronic, magnetic, optical, and/or other types of storage media. Note that the memory 610 may have a distributed architecture, where various components are situated remotely from one another but can be accessed by the processor 602. The software in memory 610 may include one or more software programs, each of which includes an ordered listing of executable instructions for implementing logical functions. The software in the memory 610 includes a suitable operating system (O/S) 614 and one or more programs 616. The operating system 614 essentially controls the execution of other computer programs, such as the one or more programs 616, and provides scheduling, input-output control, file and data management, memory management, and communication control and related services. The one or more programs 616 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

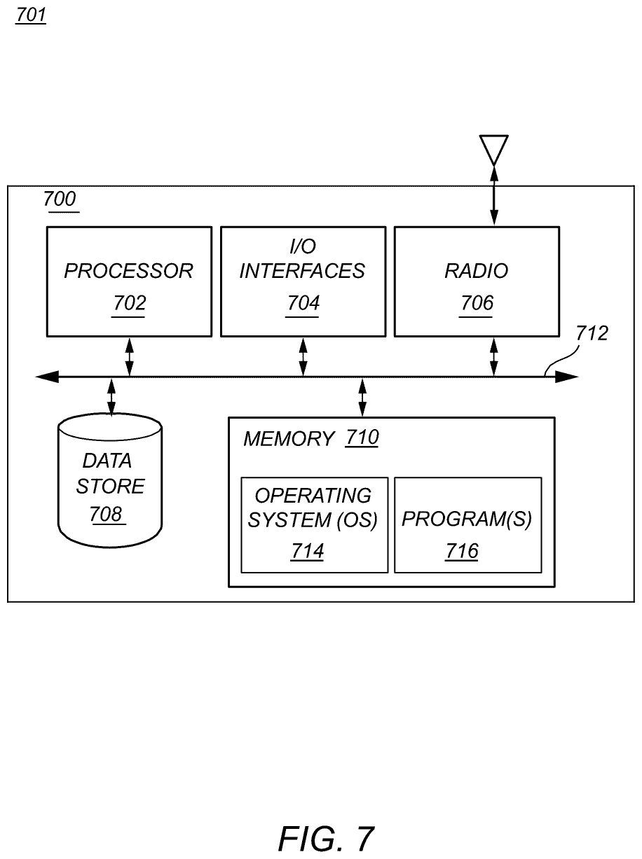

FIG. 7 is a block diagram of a user device 700, which may be used in the cloud-based system 500 (FIG. 5), as part of a network, or stand-alone. Again, the user device 700 can be a vehicle (e.g., one or more control units thereof), a smartphone, a tablet, a smartwatch, an Internet of Things (IoT) device, a laptop, a virtual reality (VR) headset, etc. The user device 700 can be a digital device that, in terms of hardware architecture, generally includes a processor 702, I/O interfaces 704, a radio 706, a data store 708, and memory 710. It should be appreciated by those of ordinary skill in the art that FIG. 7 depicts the user device 700 in an oversimplified manner, and a practical embodiment may include additional components and suitably configured processing logic to support known or conventional operating features that are not described in detail herein. The components (702, 704, 706, 708, and 710) are communicatively coupled via a local interface 712. The local interface 712 can be, for example, but is not limited to, one or more buses or other wired or wireless connections, as is known in the art. The local interface 712 can have additional elements, which are omitted for simplicity, such as controllers, buffers (caches), drivers, repeaters, and receivers, among many others, to enable communications. Further, the local interface 712 may include address, control, and/or data connections to enable appropriate communications among the aforementioned components.

The processor 702 is a hardware device for executing software instructions. The processor 702 can be any custom made or commercially available processor, a CPU, an auxiliary processor among several processors associated with the user device 700, a semiconductor-based microprocessor (in the form of a microchip or chipset), or generally any device for executing software instructions. When the user device 700 is in operation, the processor 702 is configured to execute software stored within the memory 710, to communicate data to and from the memory 710, and to generally control operations of the user device 700 pursuant to the software instructions. In an embodiment, the processor 702 may include a mobile optimized processor such as optimized for power consumption and mobile applications. The I/O interfaces 704 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 706 enables wireless communication to an external access device or network. Any number of suitable wireless data communication protocols, techniques, or methodologies can be supported by the radio 706, including any protocols for wireless communication. The data store 708 may be used to store data. The data store 708 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media.

Again, the memory 710 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 710 may incorporate electronic, magnetic, optical, and/or other types of storage media. Note that the memory 710 may have a distributed architecture, where various components are situated remotely from one another, but can be accessed by the processor 702. The software in memory 710 can include one or more software programs, each of which includes an ordered listing of executable instructions for implementing logical functions. In the example of FIG. 7, the software in the memory 710 includes a suitable operating system 714 and programs 716. The operating system 714 essentially controls the execution of other computer programs and provides scheduling, input-output control, file and data management, memory management, and communication control and related services. The programs 716 may include various applications, add-ons, etc. configured to provide end user functionality with the user device 700. For example, example programs 716 may include, but not limited to, a web browser, social networking applications, streaming media applications, games, mapping and location applications, electronic mail applications, financial applications, and the like. In a typical example, the end-user typically uses one or more of the programs 716 along with a network, such as the cloud-based system 500 (FIG. 5).

Again, embodiments of the disclosed systems and methods facilitate monitoring for specific internal or external noises relevant to operation of the vehicle. Some embodiments activate such a system in response to an indication that the driver has a hearing impairment or that the auditory environment within the cabin of the vehicle is masking sounds relevant to operation of the vehicle. Embodiments of the disclosed system utilize external auditory environmental sensors and/or internal auditory environmental sensors to isolate external or cabin noises and determine the type of noise or relevant qualities of the noise. Utilizing non-auditory interfaces of the vehicle such as displays and haptic feedback devices, embodiments of the disclosed system may provide indicators such that the operator of the vehicle may adjust to relevant sounds that would otherwise go unheard and ignored. As non-limiting examples, embodiments of the disclosed system may alert operators to unrecognized emergency vehicle sirens; faulty, flat, underinflated, or blown out tires; faulty brakes; small impacts on the vehicle itself; collisions between other vehicles in the vicinity of the vehicles, other mechanical failures of components of the vehicle that produce sound (e.g., a whining compressor or pump about to fail); horns of other vehicles in the vicinity of the vehicle, and other noises that would typically be responded to by the operator if only they were heard in the first instance.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following, non-limiting Claims for all purposes.

What is claimed is:

1. A system for supplementing audio signals for an occupant of a vehicle, the system comprising:
a plurality of environmental sensors supported relative to the vehicle,
at least one memory storing instructions that, when executed by one or more processors, cause the one or more processors to:
determine, based on signals communicated from the plurality of environmental sensors, a position of a source of a sound relative to the vehicle and at least one quality of the sound; and
generate, based on the determined relative position of the source of the sound and the at least one quality of the sound, an indicator via a non-auditory interface of the vehicle, the indicator indicating at least one of the determined position of the sound source relative to the vehicle or the determined at least one quality of the sound.

2. The system of claim 1, wherein the instructions executed by the one or more processors further cause the one or more processors to determine that the occupant has a hearing impairment, the position of the source of sound and the at least one quality of the source of sound determined in response to the determination that the occupant has the hearing impairment.

3. The system of claim 1, wherein the instructions executed by the one or more processors further cause the one or more processors to determine, based on the signals communicated from the plurality of environmental sensors, that a cabin audio environment of the vehicle masks at least one of cabin or external audio signals, the position of the source of sound and the at least one quality of the source of sound determined in response to the determination that the cabin audio environment of the vehicle masks at least one of cabin or external audio signals.

4. The system of claim 1, wherein the plurality of environmental sensors includes a cabin environmental sensor and an external environmental sensor, and wherein the instructions executed by the one or more processors further cause the one or more processors to determine, based on signals communicated from both the cabin environmental sensor and the external environmental sensor, the position of the source of the sound as either within the cabin of the vehicle or the external environment of the vehicle.

5. The system of claim 1, wherein each environmental sensor of the plurality of environmental sensors includes a microphone, an acoustic sensor, or a vibrational sensor.

6. The system of claim 1, wherein the indicator indicates the determined at least one quality of the sound including at least one of an intensity of the sound, a defective tire of the vehicle, a siren of another vehicle, a horn of another vehicle, an impact of the vehicle, a vehicular collision within a vicinity of the vehicle, a faulty brake of the vehicle, or a malfunction of the vehicle or an associated component.

7. The system of claim 1, wherein the non-auditory interface of the vehicle comprises at least one of a haptic feedback device on a steering wheel of the vehicle, an infotainment display of the vehicle, an instrument panel of the vehicle, or a heads-up display of the vehicle.

8. The system of claim 1, wherein the indicator indicates both the determined position of the sound source relative to the vehicle and the determined at least one quality of the sound.

9. The system of claim 1, wherein the instructions executed by the one or more processors further cause the one or more processors to generate, based on the determined relative position of the source of the sound and at least one quality of the sound, an additional indicator via a different non-auditory interface of the vehicle, the additional indicator indicating at least one of the determined position of the sound source relative to the vehicle or the determined at least one quality of the sound.

10. The system of claim 1, wherein the additional indicator indicates additional information relative to the indicator.

11. The system of claim 1, wherein the instructions executed by the one or more processors further cause the one or more processors to select, based on the signals communicated from the plurality of environmental sensors, the sound for generation of the indicator from a plurality of sounds.

12. The system of claim 11, wherein the sound selected for generation of the indicator is selected based on at least an importance of an event associated with generation of the sound or current driving conditions of the vehicle.

13. A vehicle comprising:
a plurality of environmental sensors;
a non-auditory interface; and
at least on memory storing instructions that, when executed by one or more processors, cause the one or more processors to implement an audio signal supplementation capability comprising:
a noise monitoring module configured to determine, based on signals communicated from the plurality of environmental sensors, a position of a source of a sound relative to the vehicle and at least one quality of the sound, and
an alert module configured to generate, based on the determined relative position of the source of the sound and the at least one quality of the sound, an indicator via a non-auditory interface of the vehicle, the indicator indicating at least one of the determined position of the sound source relative to the vehicle or the determined at least one quality of the sound.

14. The vehicle of claim 13, wherein the audio signal supplementation capability further comprises an implementation module configured to activate at least one of the noise monitoring module or the alert module based on at least one of a determination that an occupant of the vehicle has a hearing impairment or that a cabin audio environment of the vehicle masks at least one of cabin or external audio signals.

15. The vehicle of claim 13, wherein the plurality of environmental sensors includes a cabin environmental sensor and an external environmental sensor, and wherein the noise monitoring module is further configured to determine, based on signals communicated from both the cabin environmental sensor and the external environmental sensor, the position of the source of the sound as either within the cabin of the vehicle or the external environment of the vehicle.

16. The vehicle of claim 13, wherein the indicator indicates the determined at least one quality of the sound including at least one of an intensity of the sound, a defective tire of the vehicle, a siren of another vehicle, a horn of another vehicle, an impact of the vehicle, a vehicular collision within a vicinity of the vehicle, a faulty brake of the vehicle, or a malfunction of the vehicle or an associated component.

17. The vehicle of claim 13, wherein the non-auditory interface of the vehicle comprises at least one of a haptic feedback device on a steering wheel of the vehicle, an infotainment display of the vehicle, an instrument panel of the vehicle, or a heads-up display of the vehicle.

18. The vehicle of claim 13, wherein the alert module is further configured to generate, based on the determined relative position of the source of the sound and at least one quality of the sound, an additional indicator via a different non-auditory interface of the vehicle, the additional indicator indicating at least one of the determined position of the sound source relative to the vehicle or the determined at least one quality of the sound.

19. The vehicle of claim 18, wherein the additional indicator indicates additional information relative to the indicator.

20. The vehicle of claim 13, wherein the noise activation module is further configured to, based on the signals communicated from the plurality of environmental sensors, select the sound for generation of the indicator from a plurality of sounds.
